(19) United States
(12) Patent Application Publication
(10) Pub. No.: US 2015/0322696 A1
(43) Pub. Date: Nov. 12, 2015

(54) BI-DIRECTIONAL LOCK WELL-SUITED FOR PANIC-EXIT NECESSITIES

(71) Applicant: David Edmond Dudley, Oregon City, OR (US)

(72) Inventor: David Edmond Dudley, Oregon City, OR (US)

(21) Appl. No.: 14/804,380

(22) Filed: Jul. 21, 2015

Related U.S. Application Data
(60) Provisional application No. 62/034,141, filed on Aug. 6, 2014.

(51) Int. Cl. E05B 47/02; G07C 9/00; E05B 65/10; E05C 7/04; E05B 47/00

(52) U.S. Cl. CPC E05B 47/023; E05C 7/04; E05B 47/0038; E05B 65/1053; G07C 9/00111; G07C 9/00309; E05B 2047/0076; E05B 2047/0068

(57) ABSTRACT

A double acting service traffic door latch system embodiment of the present invention comprises a dual electro-mechanical lock in a single housing that is surface installed in the overhead door casings horizontally just over two bi-swing tandem warehouse security doors. Each electro-mechanical lock has two catches that drop down with a pivot arm onto either side of its respective door to prevent that door opening in either direction. A flat thin-profile housing allows the lock assembly to fit in between the tops of existing doors and their header. The doors can freely swing open if the respective catches retract back into the housing. Wireless RFID readers are used to unlock the doors when authorized users approach and are recognized. The lock is failsafe in that losing power will always unlock the doors immediately.

### BACKGROUND OF THE INVENTION

1. Field of the Invention

The present invention relates to electro-mechanical door locks, and more particularly to automatic security systems for double bi-swing warehouse doors that will allow release and unlock in emergencies in spite of unusual pressures being applied to the doors and latch.

2. Description of Related Art

Train, airline, bus, and other transportation stations all employ gates and turnstiles to control and secure various areas. These gates very often have to be able to swing both ways and yet be able to latch securely. Station agents in secure booths need to be able to unlock the gates briefly to let authorized riders and ticketholders through. Very often the way this is done in conventional systems is to use an electro-mechanical lock mechanism at the gate with wires buried in the ground or installed in the floors and walls connected to a control switch in the secure booth.

Such lock systems must survive energetic efforts by criminals to kick the gates down, and still be failsafe in the event of a power failure. The gates must unlatch when power is lost so as to not trap people from escape.

David Dudley describes such a locking mechanism for a bi-swing train station gate in U.S. Pat. No. 8,186,729, issued May 29, 2012, titled TRAPLOCK FOR BI-SWING GATE (Dudley '729).

When two large bi-swing doors are used together, such as in large liquor distribution warehouses, there is no vertical post in which a Traplock like that described by Dudley '729 can be installed. Such Traplock will not work if it is installed horizontally in the overhead door casings because the solenoids and latches will be pulled into a lockup situation by the new ways gravity is acting on them.

As an example of an installation, the FRANK ColdSwing Double Acting Cold Storage Door is used for personnel, hand truck and pallet jack traffic. The design provides quick and easy, hands-free access between separated environmentally controlled spaces. It facilitates continuous movements of people, hand trucks, and pallet jack traffic in cooler applications. These doors have windows in them, and match the performance of more traditional cold storage doors. See, frankdoor.com/product_line_double_acting_doors.php.

Compared to conventional designs, using electromagnets to repel permanent magnets attached to one side of a pivot arm can have several advantages. For example, fewer moving parts, quicker more positive response, and the latch can be made to open if electrical power is lost. But, the typical electromagnets used for door locks employ “E” cores that do not have a North-Pole, South-Pole arrangement that can be configured to repel an opposing permanent magnet. There is a need here to design one that can fit into the limited space above a warehouse bi-swing door, and still fit below the door jam. Both UL and CE certifications are important as well. This represents a next generation of warehouse door locks.

There is also a need to minimize the construction expense of having to retrofit new locking systems into existing warehouse buildings and security doors. Not having to replace or modify the existing doors is a primary consideration. Tearing up concrete or tiled floors to lay wires is also just out of the question.

### SUMMARY OF THE INVENTION

Briefly, a double acting service traffic door latch system embodiment of the present invention comprises a dual electro-mechanical lock in a single housing that is surface installed in the overhead door casings horizontally just over two bi-swing tandem security doors. Each electro-mechanical lock has two catches that drop down on either side of its respective door to prevent door opening in either direction. A flat thin-profile housing allows it to fit in between the tops of existing doors and header. The doors can swing open if the respective catches retract back into the housing. Wireless RFID readers are used to unlock the doors when authorized users approach and are recognized. The lock is failsafe in that losing power will always unlock the doors immediately.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIGS. 1A and 1B are perspective view diagrams of a pair of impact doors of a warehouse backroom that both swing open into a retail area of a store, or into its warehouse area. FIG. 1A shows the warehouse side, and FIG. 1B shows the retail side. Both show an overhead door lock mechanism of the present invention mounted above and to the center in the door jamb and header;

FIG. 1C provides an upward looking perspective view diagram of the same impact doors of FIGS. 1A and 1B, with a detail FIG. 1D of the motion sensor automatic door unlock, lock assembly enclosure, and door catches;

FIG. 2A provides downward looking perspective view diagram of the same lock mechanism shown with the impact doors of FIGS. 1A-1C, and in its “unlocked” position where the door catches are retracted;

FIGS. 2B provides downward looking perspective view diagram of the same lock mechanism shown with the impact doors of FIGS. 1A-1C, and in its “locked” position that results with the electromagnet power on;

FIGS. 3A and 3B provide top and side cross-sectional view diagrams of the same lock mechanism shown with the impact doors of FIGS. 1A-1C in its “unlocked” position;

FIGS. 4A and 4B provide top and side cross-sectional view diagrams of the same lock mechanism shown with the impact doors of FIGS. 1A-1C in its “locked” position with power on;

FIG. 4C provide a bottom perspective view diagram of the same lock mechanism showing the relationships of the protruding door catches and photosensors;

FIG. 5A is a top perspective view diagram of an alternative door lock embodiment in which the springs included in the solenoids will push the pivot arms to automatically retract the door catches if power is turned off or lost;

FIGS. 5B-5E are top view and cross-sectional view diagrams of the alternative door lock embodiment of FIG. 5A, with FIGS. 5B-C showing the unlocked status, and FIGS. 5D-5E showing the locked status;

FIG. 5F is an end view diagram of the alternative door lock embodiment of FIGS. 5A-5E, with special attention to the vertically angled inside faces of the door catches; and

FIG. 5G is an end view diagram of the alternative door lock embodiment of FIGS. 5A-5E in a typical relation to a service door distal (swinging) end, with special attention to the door's relationship to the vertically angled inside faces of the door catches.

### DETAILED DESCRIPTION OF THE INVENTION

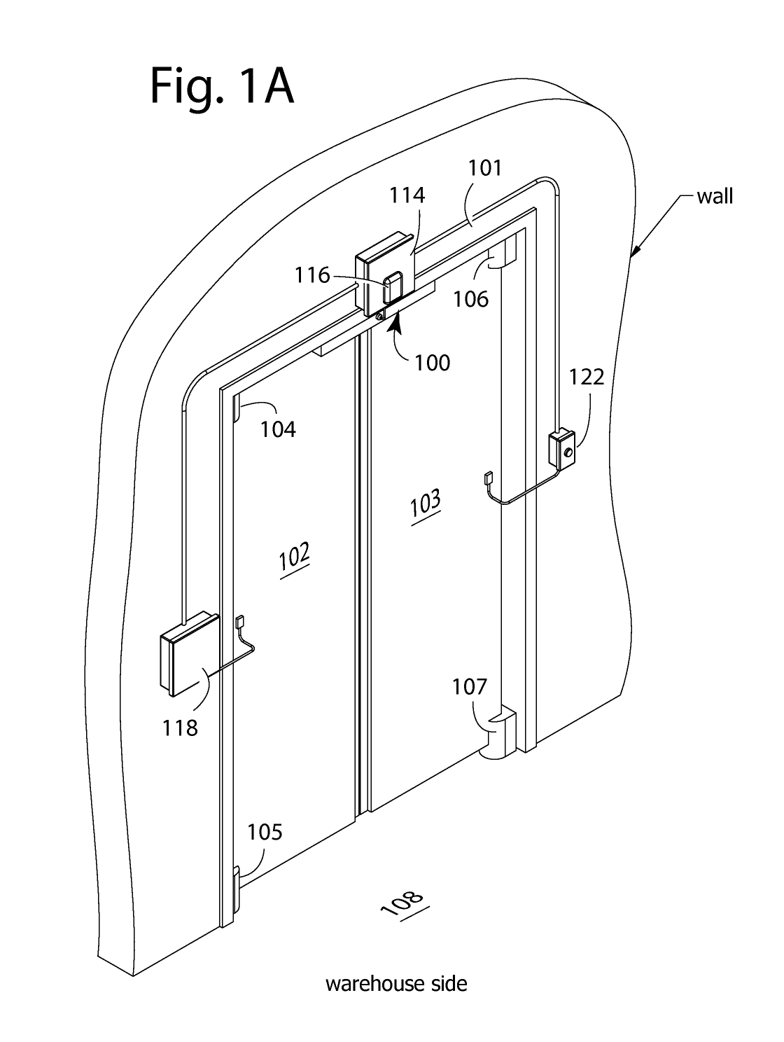

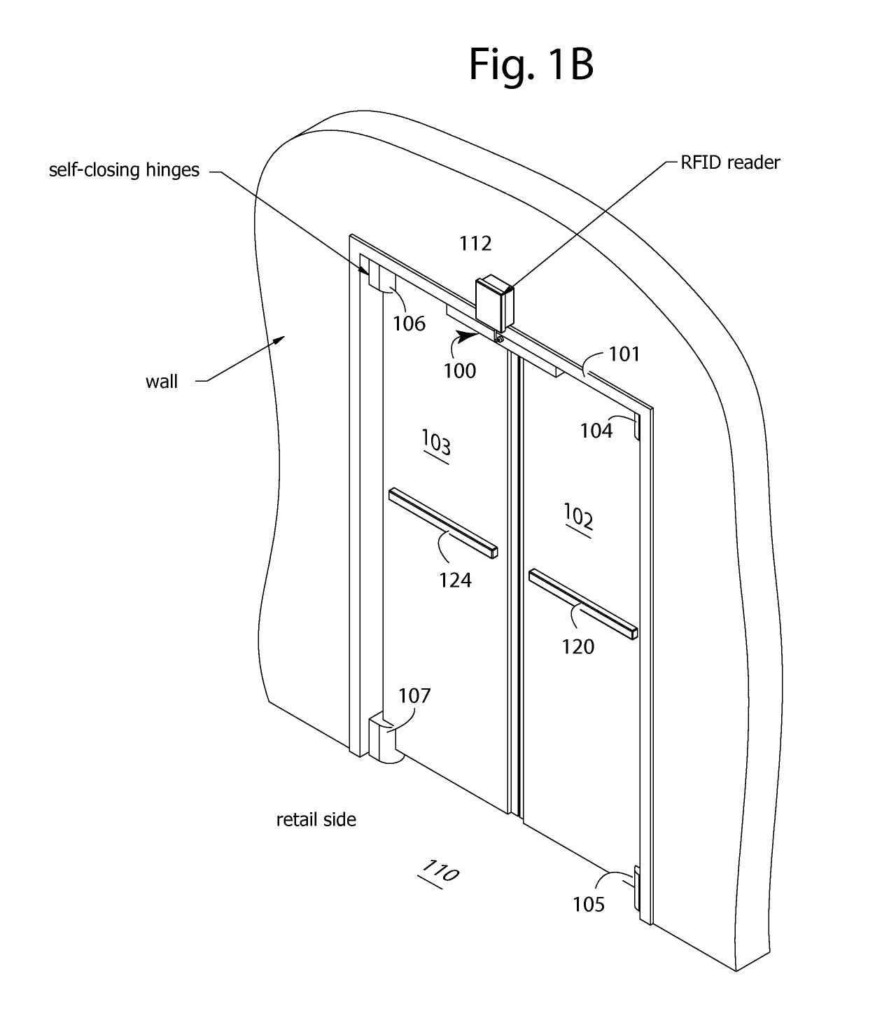

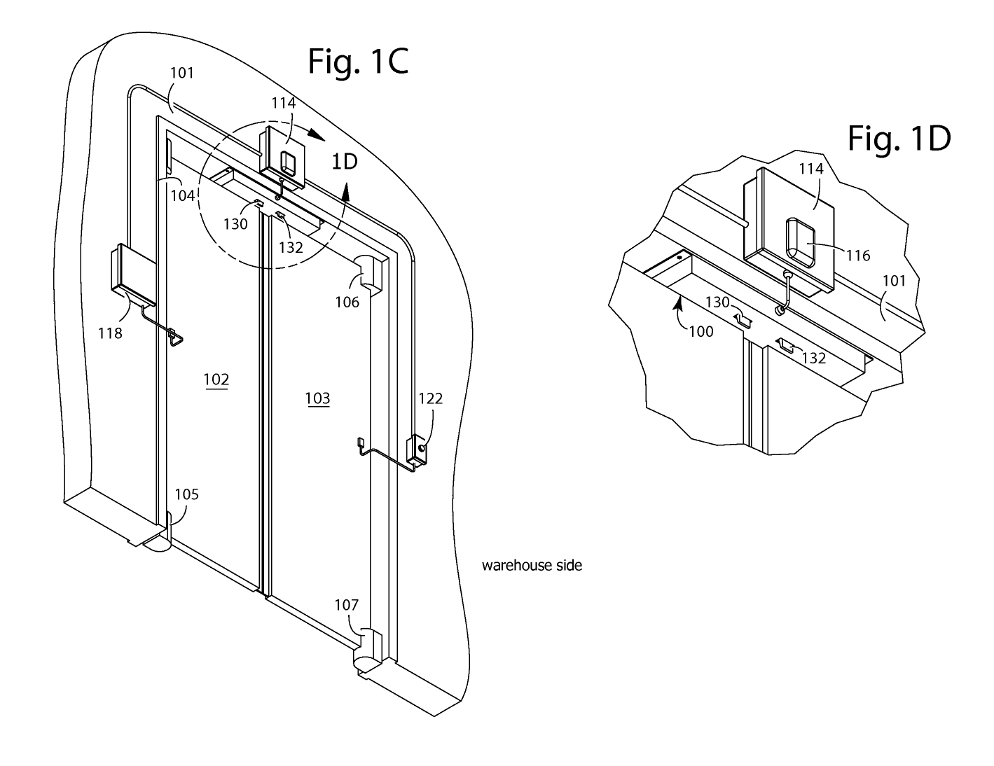

FIGS. 1A-1D show an overhead door latch mechanism 100 in an embodiment of the present invention. Such overhead door latch mechanism 100 is intended to be installed in an already existing door jamb and header 101 just above two already existing bi-swing doors 102 and 103 with self closing hinges 104-107 to both sides in door jamb and header 102. Such latching doors are commonly used between the warehouse area 108 (as seen in FIG. 1A) and a retail area 110 (as seen in FIG. 1B) of a retail operation like a large supermarket.

An RFID reader 112 on the retail side 110 will wirelessly detect an employee badge and send an unlock signal to overhead door latch mechanism 100 through a junction box 114 on the warehouse side 108. A presence sensor 116 will send a similar unlock signal to overhead door latch mechanism 100 when anyone, badge or not, approaches bi-swing doors 102 and 103 from the warehouse side 108. A control box 118 wires a “panic bar” 120 on the retail side 110 through to the overhead door latch mechanism 100 to have it unlatch both doors 102 and 103. Similarly, an emergency override switch 122 and another “panic bar” 124 on the retail side 110 wire through to the overhead door latch mechanism 100 to also have it unlatch both doors 102 and 103.

Control box 118 can be accessed by a store manager to activate or de-activate employee RFID badges. Presence sensor 116 unlocks the doors for anyone approaching from the warehouse side. An alarm will be sounded if there are no employee badges detected within range of RFID reader 112. A label is placed above panic bars 120 and 124 that reads. “PUSH for emergency exit—ALARM WILL SOUND”.

A pair of door catches 130 and 132 protruding from the bottom of overhead door latch mechanism 100 on the warehouse side 108 are just visible in FIGS. 1C and 1D. All the door catches are pushed down to trap the doors 102 and 103 when photo-sensors detect the doors are in the closed position. Each side has two door catches mounted on outside corners of a wide teeter-totter. These drop down together to lock both sides of the door to prevent doors opening in either direction.

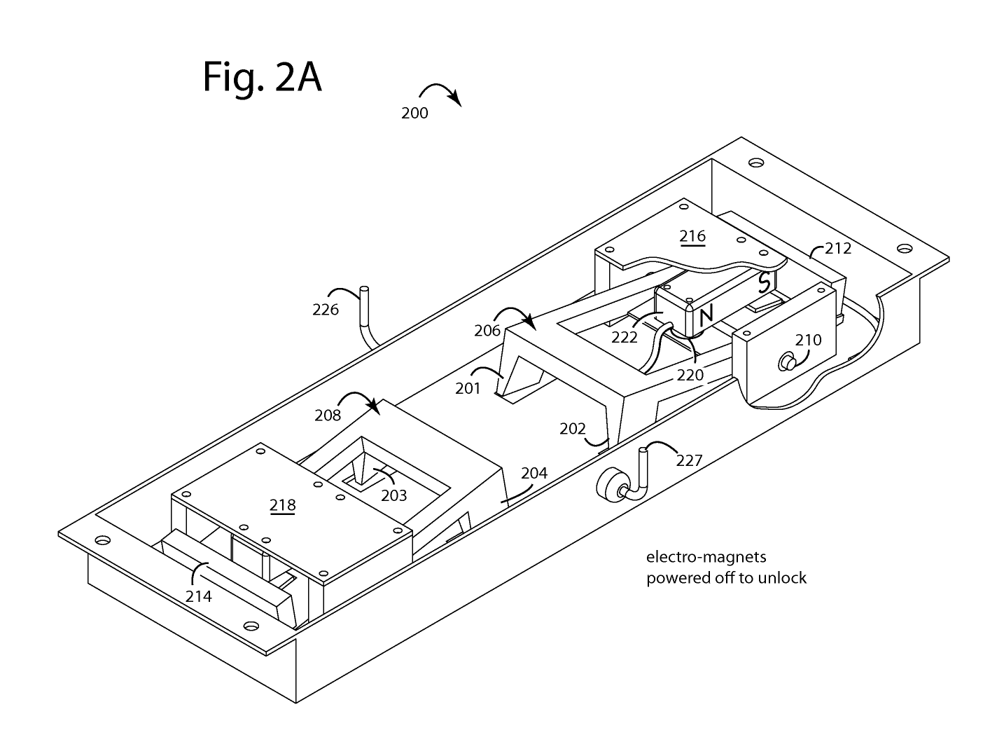

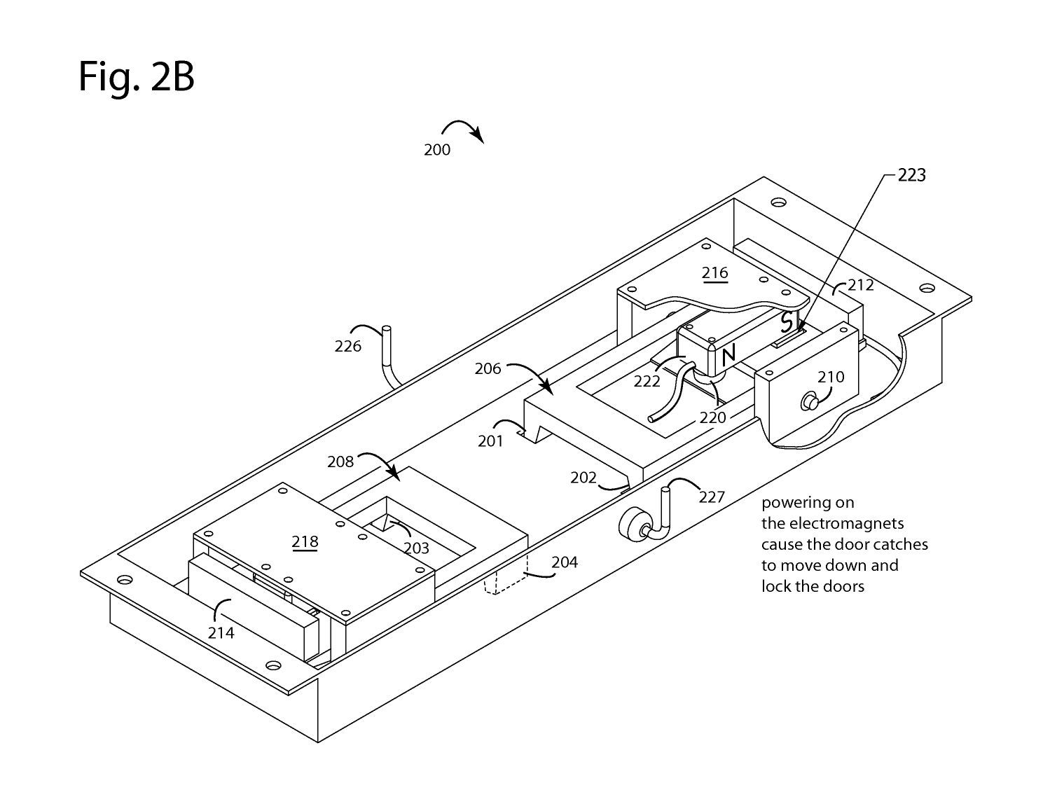

FIGS. 2A and 2B represent a tandem electro-mechanical lock 200 in an embodiment of the present invention. These are installed in the spaces available above the doors as in FIGS. 1A-1D. In reality, door catches 201-204 are integrated into the outside corners of two independent, wide “teeter-totters” 206 and 208. They teeter-totter on shaft pivots 210 and are counter balanced by counterweights 212 and 214. A frame 216 supports shaft pivot 210, counterweight 212, teeter-totter 206, and door catches 201 and 202. Similarly, a second frame 218 supports a shaft pivot (not visible here), counterweight 214, teeter-totter 208, and door catches 203 and 204.

The tapering of the faces of door catches 201-204, seen in FIG. 2A, is important and discussed more fully below.

Since FIGS. 2A and 2B provide only one better inside view of the first of the two electro-mechanical locks, the following discussion will also have to apply as well to the second of the two electro-mechanical locks. A permanent magnet 220 is fixed to teeter-totter 206 and positioned to interact with an electro-magnet 222 mounted to frame 216. FIG. 2A represents the power off, unlocked position of teeter-totter 206. FIG. 2B represents the power on, locked position of teeter-totter 206.

In FIG. 2A, door catches 201-204 are all retracted because the electro-magnet 222 is off and produces no magnetic force to interact with permanent magnet 220. So, the kinetic force applied by gravity acting on the counterweight 212 predominates. Wire pigtails 226 and 227 connect to RFID reader 112 and presence sensor 116.

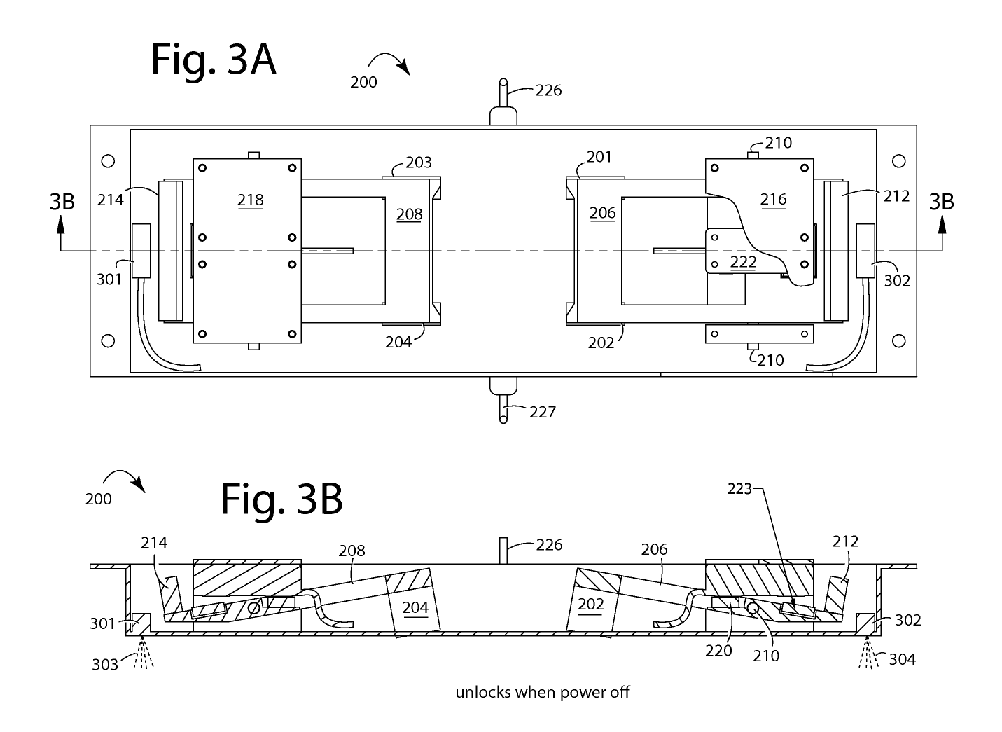

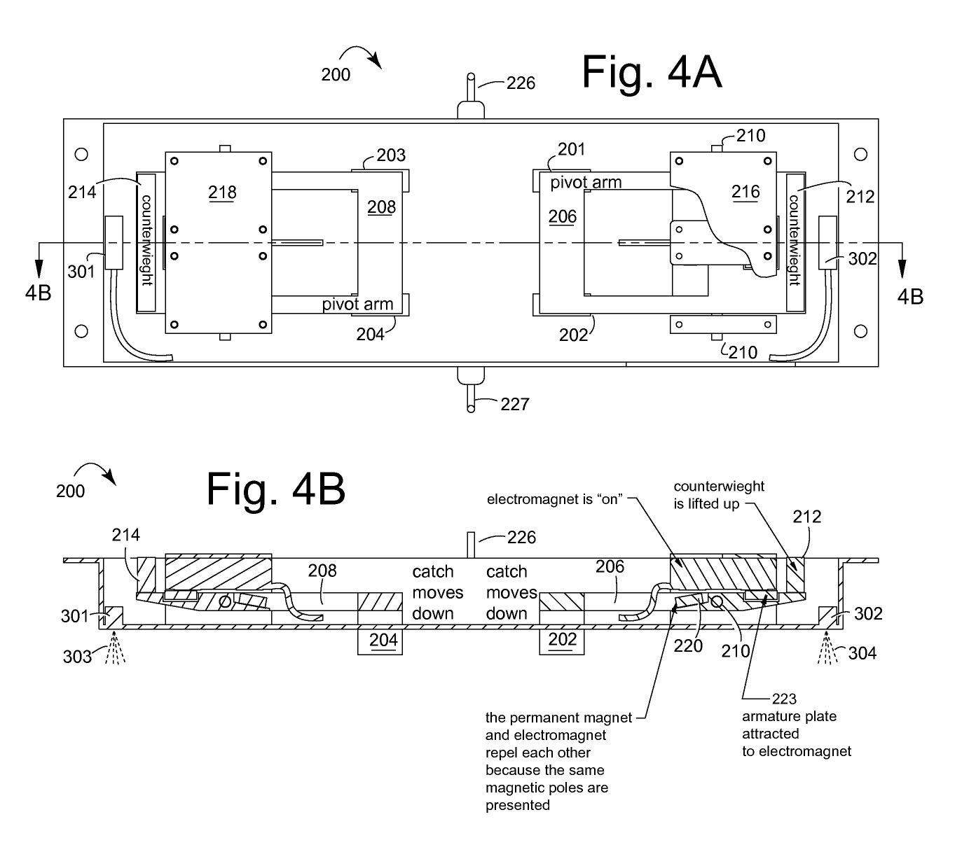

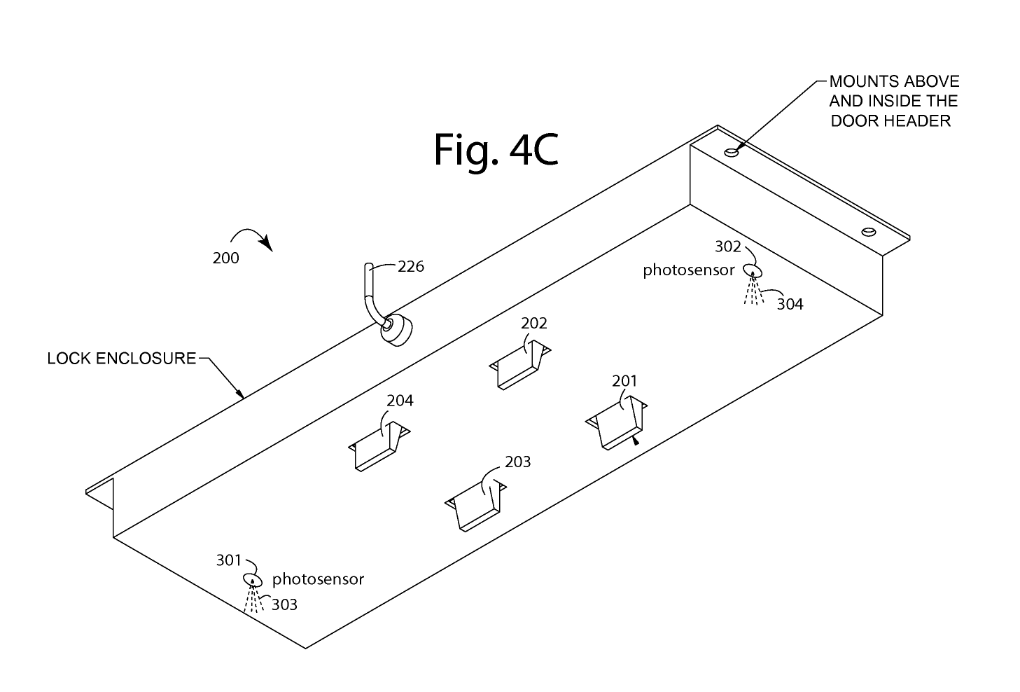

FIGS. 3A, 3B, 4A, and 4B represent the same tandem electro-mechanical lock 200 of FIGS. 2A and 2B, so the same element numbering is continued. FIGS. 3A, 3B, 4A, and 4B are provided for their helpful views of the mechanical pieces and to further this description here of the operation.

Now, in FIGS. 3A, 3B, 4A, and 4B a pair of photo-sensors 301 and 302 are shown with emitted light beams 303 and 304.

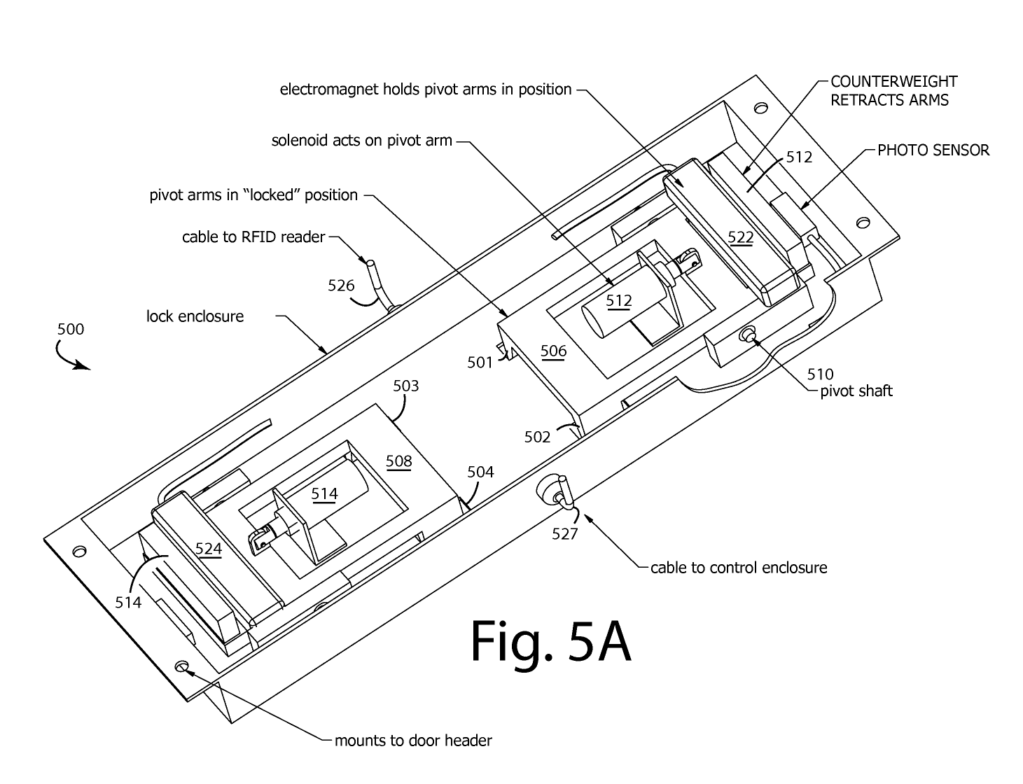

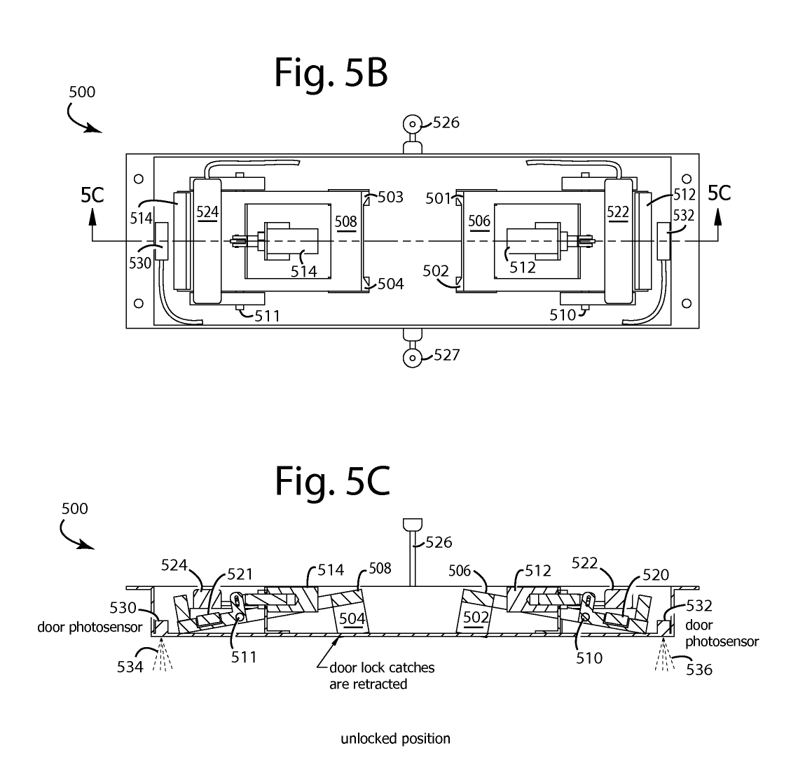

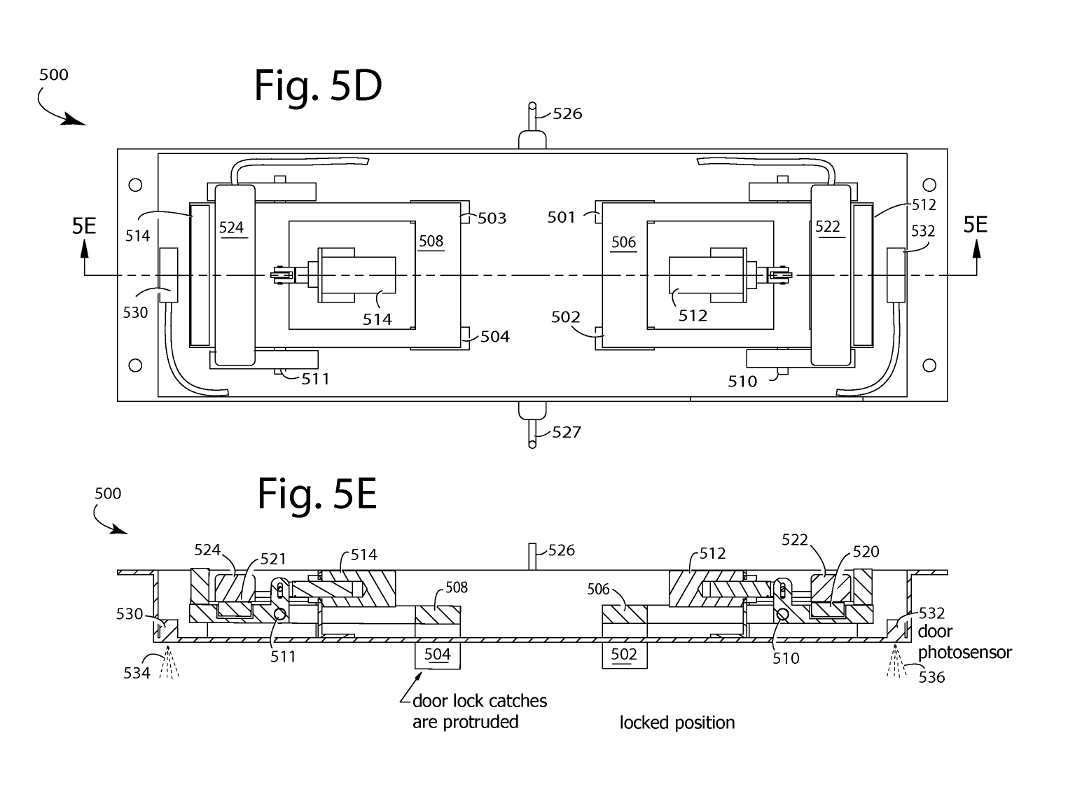

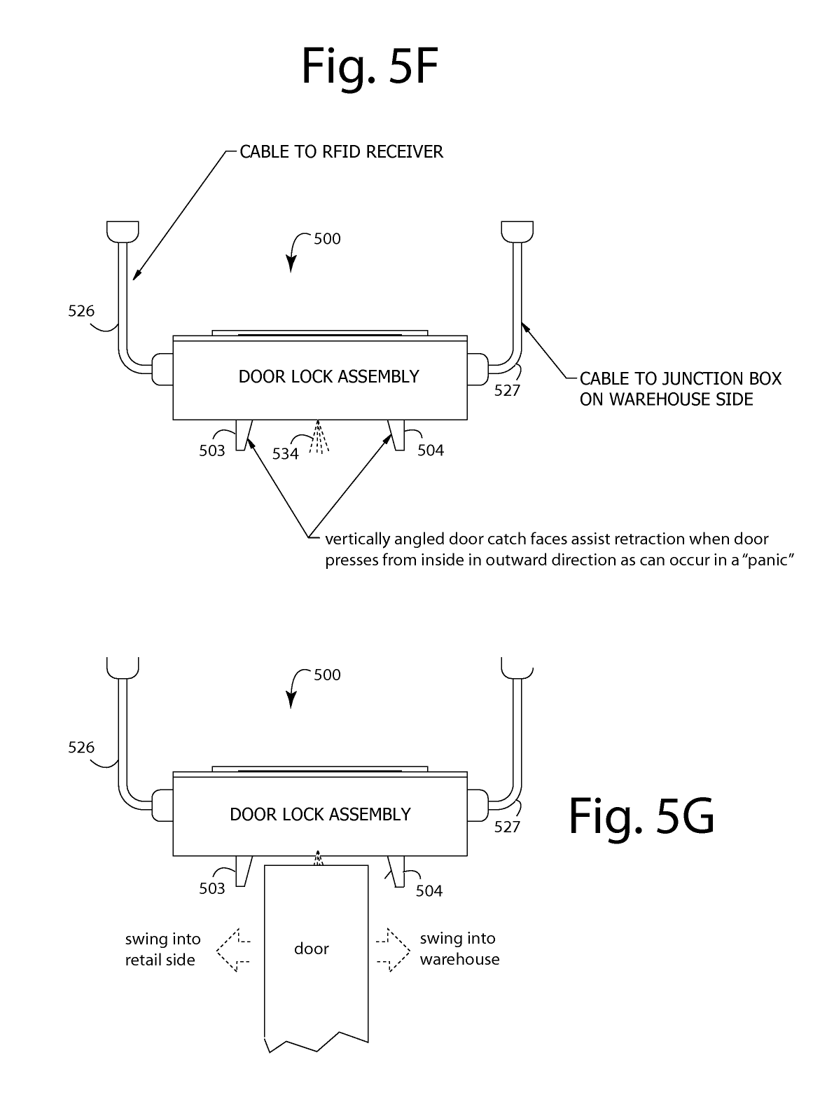

FIGS. 5A-5F represent a door lock mechanism 500 in an alternative embodiment of the present invention that uses a solenoid with a compression spring instead of a permanent magnet. The spring-loaded solenoid enables a positive return to an unlocked state when power if off. The position of the electromagnet is thus changed, compared to the above, and the solenoid is energized to pull on the pivot arm and the spring will push it back.

Here, door catches 501-504 are integrated into the outside corners of two independent, wide teeter-totter pivot arms 506 and 508. They seesaw on shaft pivots 510 (511 in FIGS. 5B and 5C) and are counter-balanced by counterweights 512 and 514. A pair of spring-loaded solenoids 512 and 514 are mounted to a supporting frame to pull and push on their respective pivot arms 506 and 508, depending on the application of electrical current to them from a controller circuit. The spring loading is intended to automatically retract the door lock catches if power is turned off or otherwise lost.

Armature plates 520 and 521 (FIG. 5C) are fixed to pivot arms 506 and 508, and in positions that can interact with electro-magnets 522 and 524. FIG. 5A represents the power off, unlocked position of pivot arm 506. FIG. 5B-5C represents the power off, unlocked position of pivot arms 506 and 508. Door catches 501-504 are all retracted because the electro-magnet 522 is off and produces no magnetic force to interact with armature plate 520. The spring pressure in solenoid 512 predominates. Wire pigtails 526 and 527 connect to RFID reader 112 (FIGS. 1A-1B) and presence sensor 116. A pair of photo-sensors 530 and 532 are shown with emitted light beams 534 and 536.

The photosensors report if either door is open or closed. The doors are allowed to swing open when the respective catches unlatch. As the door is opened, the catches are actively and electrically pushed down to catch the door when it automatically recloses.

Referring now to FIG. 5G, a principal design challenge was to make a bidirectional door lock that was secure and yet able to open with an emergency exit panic device. Using a combination of an electromagnet holding the door catches in the lock position and a slight angle on the faces of the door catches enables the doors to pop open even though there may be pressure being applied to the doors, such as might happen in a panic situation. Without the angle on the door catches, normal friction would too much and keep the catches from releasing the door.

Using an electromagnet also helps because when power is turned off, it no longer sustains any resistance to the arms pivoting upward, because it's holding force is perpendicular to the armature plate in the arm. In our other Trap-lock designs there was a pin that came down behind the door catch arms. If the door was being pushed on when the power was turn off, the pin would not slide freely to release the arms because of friction created by the pushing force on the doors.

This combination of features (electromagnetic lock and slightly angled door catches) could be used in different configurations of the bi-directional lock to make it compatible with a panic exit device.

In general, double-acting service-traffic door latch system embodiments of the present invention include a combination of an electromagnet and a permanent magnet or armature plate mounted in opposition to one another between a pivot arm and a supporting frame. A pair of door catches are set downwardly protruding from and mounted to opposite corners of a distal end of the pivot arm. They are separated by more than the width of a double acting service traffic door. A counterweight is mounted to the pivot arm at an end opposite to the pair of door catches. It is balanced to retract the door catches if the electromagnet is not then generating a magnetic field caused by an electrical current flow. An electrical control circuit is connected to the electromagnet and is able to switch-on an electrical current flow. This is sufficient to generate a magnetic field in the electromagnet that will interact with the permanent magnet or armature plate and force the pair of door catches downward on the pivot arm to protrude out and to lock both sides of the double acting service traffic door. A photo-sensor is mounted to detect if the double acting service traffic doors are closed. It is connected to the electrical control circuit to allow locking the double acting service traffic door if the door is actually closed. A wireless radio receiver is mounted to detect if an authorized person with a radio frequency identification (RFID) badge is within radio range, e.g., 20-30 feet. It is also connected to the electrical control circuit to cause an unlocking of the double acting service traffic doors by interrupting the electrical currents applied to the electromagnets. A panic bar is mounted to at least one double acting service traffic door, and is connected to the electrical control circuit to cause an unlocking by switching off any electrical current applied to the electromagnet. A machined beveling is imparted to the inward facing surfaces of the pair of door catches that assists in a retraction of the pair of door catches to unlock the double acting service traffic door whenever the electrical current applied to the electromagnet is switched off or lost.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. A double-acting service-traffic door latch system, comprising:
a combination of an electromagnet, a permanent magnet, and an armature plate mounted in opposition to one another between a pivot arm and a supporting frame;
a pair of door catches downwardly protruding from and mounted to opposite corners of a distal end of the pivot arm and separated by more than the width of a double acting service traffic door;
a counterweight mounted to the pivot arm at an end opposite to the pair of door catches and balanced to retract the pair of door catches if the electromagnet is not then generating a magnetic field caused by an electrical current flow;
an electrical control circuit connected to the electromagnet and able to switch on an electrical current flow sufficient to generate a magnetic field in the electromagnet that will interact with the permanent magnet and armature plate and force the pair of door catches downward on the pivot arm to protrude out and lock both sides of the double acting service traffic door and lock them shut;
a photo-sensor mounted to detect if the double acting service traffic door is closed, and connected to the electrical control circuit to allow locking the double acting service traffic door if it is closed;
a wireless radio receiver mounted to detect if an authorized person with an RFID badge is within radio range of the double acting service traffic door, and connected to the electrical control circuit to cause an unlocking the double acting service traffic door by interrupting the electrical current applied to the electromagnet;
a panic bar mounted to the double acting service traffic door, and connected to the electrical control circuit to cause an unlocking of the double acting service traffic door by switching off any electrical current applied to the electromagnet; and
a beveling applied to the inward facing surfaces of the pair of door catches that assists in a retraction of the pair of door catches to unlock the double acting service traffic door whenever the electrical current applied to the electromagnet is switched off or lost.

2. A double-acting service-traffic door latch system, comprising:
a combination of an electromagnet and a permanent magnet mounted in opposition to one another between a pivot arm and a supporting frame;
a pair of door catches downwardly protruding from and mounted to opposite corners of a distal end of the pivot arm and separated by more than the width of a double acting service traffic door;
a counterweight mounted to the pivot arm at an end opposite to the pair of door catches and balanced to retract the pair of door catches if the electromagnet is not then generating a magnetic field caused by an electrical current flow; and
an electrical control circuit connected to the electromagnet and able to switch on an electrical current flow sufficient to generate a magnetic field in the electromagnet that will interact with the permanent magnet and force the pair of door catches downward on the pivot arm to protrude out and lock both sides of the double acting service traffic door.

3. The double-acting service-traffic door latch system of claim 2, further comprising:
a photo-sensor mounted to detect if the double acting service traffic door is closed, and connected to the electrical control circuit to allow locking the double acting service traffic door if it is closed.

4. The double-acting service-traffic door latch system of claim 2, further comprising:
a wireless radio receiver mounted to detect if an authorized person with an RFID badge is within radio range of the double acting service traffic door, and connected to the electrical control circuit to cause an unlocking the double acting service traffic door by interrupting the electrical current applied to the electromagnet.

5. The double-acting service-traffic door latch system of claim 2, further comprising:
a panic bar mounted to the double acting service traffic door, and connected to the electrical control circuit to cause an unlocking the double acting service traffic door by switching off any electrical current applied to the electromagnet.

6. The double-acting service-traffic door latch system of claim 2, further comprising:
a beveling applied to the inward facing surfaces of the pair of door catches that assists in a retraction of the pair of door catches to unlock the double acting service traffic door whenever the electrical current applied to the electromagnet is switched off or lost.

7. The double-acting service-traffic door latch system of claim 2, further comprising:
an electrical solenoid in place of the permanent magnet that is attached between the pivot arm and the supporting frame, wherein electrical current applied to it causes the doors to be locked and electrical current applied to the electromagnet can maintain a locked-door condition.
